(19) United States
(12) Patent Application Publication
(10) Pub. No.: US 2016/0095278 A1
(43) Pub. Date: Apr. 7, 2016

(54) PRODUCE GATHERING DEVICE

(71) Applicants: Sharon Slater, Fort Worth, TX (US); George Slater, Fort Worth, TX (US)

(72) Inventors: Sharon Slater, Fort Worth, TX (US); George Slater, Fort Worth, TX (US)

(21) Appl. No.: 14/508,195

(22) Filed: Oct. 7, 2014

(51) Int. Cl. A01D 46/22

(52) U.S. Cl. CPC A01D 46/22

(57) ABSTRACT

A produce gathering device comprising a housing, where the housing resembles a backpack; a pair of straps on a back side of the housing, where the pair of straps allow the housing to be worn by a user; a vacuum device within the housing; a hose coupled to the vacuum device, where the hose suctions a plurality of food items; a storage container within the housing, where the storage container receives the plurality of food items suctioned through the hose; and a power source for the vacuum device, where the power source is activated by an activation switch.

### BACKGROUND OF THE INVENTION

1. Field of the Invention

The present invention relates to a vacuum worn by a user to pick up and collect food items from the user's garden.

2. Description of Related Art

Gardening is an activity enjoyed by many which results in beautiful plants, flowers and even produce. Many home gardeners may grow fruits and veggies for their family's daily consumption thereby contributing to the family's overall health and wellbeing. The home grown produce typically has more flavor and nutrients than those bought at a grocery store, which is why many people choose to grow their own food. The food and even herbs are always fresh, making their home cooked meals more enjoyable for all who consume.

While gardening is a pleasure for many people seeing the fruitful abundance of their hard work and labor, the task of gathering and harvesting is often thought of as a dreaded chore. Since many fruits and vegetables are grown either on or in the ground or in a tree, the gardener must repeatedly bend and straighten to gather the food. With the repeated movement the person's back is usually strained which may cause short term or even permanent damage to the area. Additionally, once the produce has been amassed, the collection bins or baskets must be carried inside before consumption. Transporting the collection bins themselves is strenuous to the back especially when a plentiful harvest was produced.

Therefore it would be beneficial in the art to provide a device that assists a gardener when collecting food from their garden by relieving them from having to repeatedly bend over to pick up the food. It would also be desirable in the art to provide a device that also helps to store the food gathered.

### SUMMARY OF THE INVENTION

In view of the foregoing disadvantages inherent in the prior art, the general purpose of the present invention is to provide a produce gathering device to collect food items in a garden, orchard or farm, configured to include all of the advantages of the prior art, and to overcome the drawbacks inherent therein.

Accordingly, an object of the present invention is to provide a produce gathering device which is worn by a user and includes an internal vacuum to pick up produce items.

Another object of the present invention is to provide a produce gathering device with an internal storage compartment to allow the produce collected to remain within the device so that the user may easily carry the fruit they collects additional items.

To achieve the above objects, in an aspect of the present invention, a produce gathering device is described comprising a housing, where the housing resembles a backpack; a pair of straps on a back side of the housing, where the pair of straps allow the housing to be worn by a user; a vacuum device within the housing; a hose coupled to the vacuum device, where the hose suctions a plurality of food items; a storage container within the housing, where the storage container receives the plurality of food items suctioned through the hose; and a power source for the vacuum device, where the power source is activated by an activation switch.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a produce gathering device in accordance with an exemplary embodiment of the present invention; and

FIG. 2 depicts a back side view of a produce gathering device in accordance with an exemplary embodiment of the present invention.

Like reference numerals refer to like parts throughout the description of several views of the drawings.

### DETAILED DESCRIPTION OF THE DRAWINGS

The present invention relates to a vacuum worn by a user to pick up and collect food items from the user's garden. The present invention provides a produce gathering device to facilitate the process of picking fruits and vegetables. The produce gathering device includes a vacuum device that is housed within a backpack. The vacuum includes a hose which picks up the desired produce for the user. Within the backpack is a storage container to hold the fruits and vegetables collected with the hose. With the produce gathering device the user does not have to repeatedly bend over to pick up their items, thereby saving their back and making gardening more enjoyable.

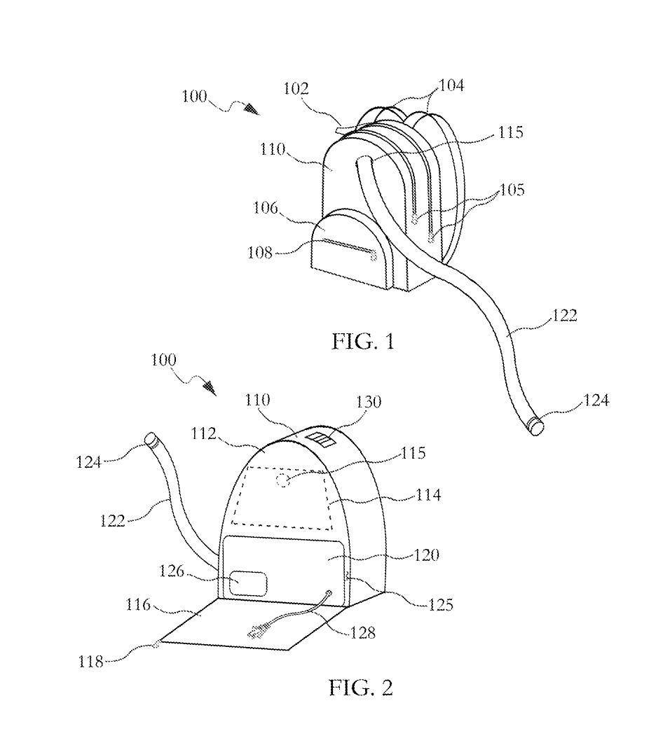

Turning now descriptively to the drawings, referring to FIG. 1, a perspective view of a produce gathering device 100 is shown in accordance with an exemplary embodiment of the present invention. The produce gathering device 100 incudes a housing 110 with a pair of straps 104 to enable the housing 110 to be worn and supported by a user. The housing 110 may resemble a backpack, knapsack or other similarly worn storage containers. The straps 104 extend from a top portion to a bottom portion of the back face of the housing 110 for even weight distribution. Further, the straps 104 may be padded for additional comfort, especially when supporting a lot of weight. The housing 110 includes a pair of zipper closures 102 positioned along a top portion to enable the user access to the inner contents of the housing 110. The zipper closures 102 may include handles 105 or tabs to easily open and close the housing 110. Attached to a front face of the housing 110 may be a pouch 106. The pouch 106 provides additional storage capacity for the housing 110, and includes a closure 108 to secure any items within the pouch 106.

Extending from the housing 110 may be a hose 122 which is connected at an inlet 115. The hose 122 is coupled to a vacuum device within the housing 110. The vacuum device is described below in reference to FIG. 2. The hose 122 includes a nozzle 124 at an opposite end from the inlet 115 which is directed by the user towards the object they wish to pick up. The nozzle 124 may be elongated and rigid to allow the user to easily reach items out of their grasp. The nozzle 124 may adjust the amount of suction that passes through the hose 122, and may even stopper the suction all together. The hose 122 may be made from a clear plastic or rubber to enable the user to view the item as they pass through the hose 122 and into the housing 110.

Referring now to FIG. 2, a back side view of the produce gathering device 100 is shown in accordance with an exemplary embodiment of the present invention. The straps 104 are not illustrated for simplicity. The back panel 112 of the housing 110 may include a flap 116 that when opened reveals the vacuum device 120. The flap 116 may open a portion of the back panel 112 (as shown) or it may open the entire panel. The flap 116 includes a closure 118 to secure the flap 116 against the back panel 112. The closure 118 may be a zipper, hook and loop fastener, snaps, ties, buttons or the like.

The vacuum device 120 provides the suction power for the hose 122 to collect the produce items. Once the items are retrieved by the hose 122 they are deposited into a storage container 114 within the housing 110. The storage container 114 collects the produce to prevent damage to the fruits and vegetables while continuing to use the vacuum device 120. The produce may be suctioned directly into the storage container 114 through the inlet 115 that is connected to the hose 122, or they may be placed manually by opening one of the zipper closures 102. This may be ideal for larger pieces that do not fit though the hose 122. The suction of the vacuum device 120 through the hose 122 is strong enough to allow the user to pick up large food items by suctioning them against the nozzle 124 without them dropping. The user may then manually place the food within the housing 110.

The vacuum device 120 may be battery operated with a battery compartment 126 to house a set of rechargeable batteries. A power cord 128 may be used as an alternative power source or to charge the batteries within the compartment 126. Finally, solar panels 130 may attach to the top portion of the housing 110 to provide solar power to the vacuum device 120. An activation switch 125 may be positioned on a side of the vacuum device 120 to activate power as needed to the device 120.

With the produce gathering device 100 the user is afforded an easy to use collection and storage device that saves them effort when collecting various items in a garden, orchard or farm. They no longer have to repeatedly strain their back as they reach to pick up and gather the food items. By allowing lightweight portability and self-contained power, the produce gathering device 100 may be conveniently operated in any location of the user's choosing.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A produce gathering device comprising:
a. a housing, where the housing resembles a backpack;
b. a pair of straps on a back side of the housing, where the pair of straps allow the housing to be worn by a user;
c. a vacuum device within the housing;
d. a hose coupled to the vacuum device, where the hose suctions a plurality of food items;
e. a storage container within the housing, where the storage container receives the plurality of food items suctioned through the hose; and
f. a power source for the vacuum device, where the power source is activated by an activation switch.

2. The produce gathering device according to claim 1, where the housing includes a least one zipper closure along a top portion of the housing, where the zipper closure enables access into the housing.

3. The produce gathering device according to claim 1, where the housing includes a pouch with a closure, where the pouch provides additional storage capacity for the housing.

4. The produce gathering device according to claim 1, where the power source is a plurality of batteries housed within a battery compartment.

5. The produce gathering device according to claim 4, where the plurality of batteries are rechargeable.

6. The produce gathering device according to claim 1, where the power source is electrical power via an electrical cord.

7. The produce gathering device according to claim 1, where the power source is solar power, where at least one solar panel is positioned on the housing to provide the solar power.

8. The produce gathering device according to claim 1, where the housing includes a flap on a back panel of the housing, where the flap opens the back panel to reveal the vacuum device.

9. The produce gathering device according to claim 8, where the flap includes a closure to secure the flap against the back panel.

10. The produce gathering device according to claim 9, where the closure is one of at least a hook and loop fastener, zipper, buttons, snaps, or ties.
